(19) United States
(12) Patent Application Publication
(10) Pub. No.: US 2026/0029657 A1
(43) Pub. Date: Jan. 29, 2026

(54) LINE NARROWING MODULE, NARROWED-LINE LASER APPARATUS, AND METHOD FOR MANUFACTURING ELECTRONIC DEVICES

(71) Applicant: Gigaphoton Inc., Oyama-shi (JP)

(72) Inventors: Toshihiro KOBAYASHI, Oyama-shi (JP); Osamu WAKABAYASHI, Oyama-shi (JP); Daisuke TEI, Oyama-shi (JP)

(73) Assignee: Gigaphoton Inc., Oyama-shi (JP)

(21) Appl. No.: 19/348,341

(22) Filed: Oct. 2, 2025

Related U.S. Application Data
(63) Continuation of application No. PCT/JP2023/020049, filed on May 30, 2023.

(51) Int. Cl. G02B 27/09; G02B 1/02

(52) U.S. Cl. CPC G02B 27/0972; G02B 1/02; G02B 27/0944

(57) ABSTRACT

A line narrowing module includes an enlarging optical system configured to enlarge and output laser light; and a grating configured to reflectively diffract the laser light output from the enlarging optical system, and the enlarging optical system includes a first quartz crystal prism so disposed that an optic axis thereof is perpendicular to a light incident plane of the laser light entering the first quartz crystal prism in such a way that the laser light approaches the grating, and a synthetic quartz prism disposed at a position closest to the grating.

### CROSS-REFERENCE TO RELATED APPLICATIONS

The present application is a continuation application of International Application No. PCT/JP2023/020049, filed on May 30, 2023, the entire contents of which are hereby incorporated by reference.

### BACKGROUND

### 1. Technical Field

The present disclosure relates to a line narrowing module, a narrowed-line laser apparatus, and a method for manufacturing electronic devices.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

The light from the KrF and ArF excimer laser apparatuses undergoing spontaneous laser oscillation has a wide spectral linewidth ranging from 350 to 400 pm. A projection lens made of a material that transmits ultraviolet light, such as KrF and ArF laser light, therefore produces chromatic aberrations in some cases. As a result, the resolution of the projection lens may decrease. To avoid the decrease in the resolution, the spectral linewidth of the laser light output from the laser apparatus needs to be narrow enough to make the chromatic aberrations negligible. To this end, a line narrowing module (LNM) including a line narrowing element (such as etalon or grating) is provided in some cases in a laser resonator of the laser apparatus to narrow the spectral linewidth. A laser apparatus providing a narrowed spectral linewidth is referred to as a narrowed-line laser apparatus.

### CITATION LIST

### Patent Literature

PTL 1: European Patent Application Publication No. 1041689

PTL 2: JP-A-03-139893

### SUMMARY

In one aspect of the present disclosure, a line narrowing module includes an enlarging optical system configured to enlarge and output laser light; and a grating configured to reflectively diffract the laser light output from the enlarging optical system, and the enlarging optical system includes a first quartz crystal prism so disposed that an optic axis thereof is perpendicular to a light incident plane of the laser light entering the first quartz crystal prism in such a way that the laser light approaches the grating, and a synthetic quartz prism disposed at a position closest to the grating.

In another aspect of the present disclosure, a narrowed-line laser apparatus includes a line narrowing module including an enlarging optical system configured to enlarge and output laser light, and a grating configured to reflectively diffract the laser light output from the enlarging optical system; an output coupling mirror; and a laser chamber disposed in an optical path of an optical resonator and including a pair of discharge electrodes, the optical resonator including the line narrowing module and the output coupling mirror. The enlarging optical system includes a first quartz crystal prism so disposed that an optic axis thereof is perpendicular to a light incident plane of the laser light entering the first quartz crystal prism in such a way that the laser light approaches the grating, and a synthetic quartz prism disposed at a position closest to the grating.

In another aspect of the present disclosure, a method for manufacturing electronic devices includes generating laser light by using a narrowed-line laser apparatus; outputting the laser light to an exposure apparatus; and exposing a photosensitive substrate to the laser light in the exposure apparatus to manufacture the electronic devices. The narrowed-line laser apparatus includes a line narrowing module including an enlarging optical system configured to enlarge and output laser light, and a grating configured to reflectively diffract the laser light output from the enlarging optical system, an output coupling mirror, and a laser chamber disposed in an optical path of an optical resonator and including a pair of discharge electrodes, the optical resonator including the line narrowing module and the output coupling mirror. The enlarging optical system includes a first quartz crystal prism so disposed that an optic axis thereof is perpendicular to a light incident plane of the laser light entering the first quartz crystal prism in such a way that the laser light approaches the grating, and a synthetic quartz prism disposed at a position closest to the grating.

### BRIEF DESCRIPTION OF DRAWINGS

Some embodiments of the present disclosure will be described below only by way of example with reference to the accompanying drawings.

FIG. 1 diagrammatically shows the configuration of a narrowed-line laser apparatus including a line narrowing module according to Comparative Example.

FIG. 2 diagrammatically shows the configuration of the narrowed-line laser apparatus including the line narrowing module according to Comparative Example.

FIG. 3 is a graph showing changes in PointingV according to the duration of a continuous operation of the narrowed-line laser apparatus according to Comparative Example.

FIG. 4 is a table showing candidates of a substance that constitutes an optical path of an enlarging optical system and the temperature dependence of the refractive indices of the candidate substances.

FIG. 5 shows a simplified configuration of a narrowed-line laser apparatus according to a first embodiment.

FIG. 6 shows a state in which light output from a laser chamber passes through a prism toward a grating.

FIG. 7 shows the relationship of an angle between an optical path axis and an optic axis of quartz crystal with an ordinary refractive index and an extraordinary refractive index.

FIG. 8 shows the relationship between the angle of the optical path axis with respect to the optic axis of the quartz crystal and the optical rotation intensity.

FIG. 9 shows combination examples of materials of which prisms that constitute the enlarging optical system are made.

FIG. 10 shows results of calculation of the optical path length ratios and PointingV for each of the materials of which the prisms are made in each combination example.

FIG. 11 schematically shows the configuration of an exposure apparatus connected to the narrowed-line laser apparatus.

### DETAILED DESCRIPTION

### Contents

1. Narrowed-line laser apparatus 1 according to Comparative Example
1.1 Configuration
1.2 Operation
1.3 Problems with Comparative Example
2. Line narrowing module 14 including prisms made of quartz crystal and synthetic quartz
2.1 Alternative material for calcium fluoride
2.2 Configuration
2.3 Effects
3. Arrangement of prisms made of various materials
3.1 Configuration
3.2 Effects
4. Others
4.1 Exposure apparatus 100
4.2 Supplements

Embodiments of the present disclosure will be described below in detail with reference to the drawings. The embodiments described below show some examples of the present disclosure and are not intended to limit the contents of the present disclosure.

Furthermore, all configurations and operations described in the embodiments are not necessarily essential as configurations and operations in the present disclosure. Note that the same elements have the same reference characters, and no redundant description of the same elements will be made.

### 1. Narrowed-Line Laser Apparatus 1 According to Comparative Example

### 1.1 Configuration

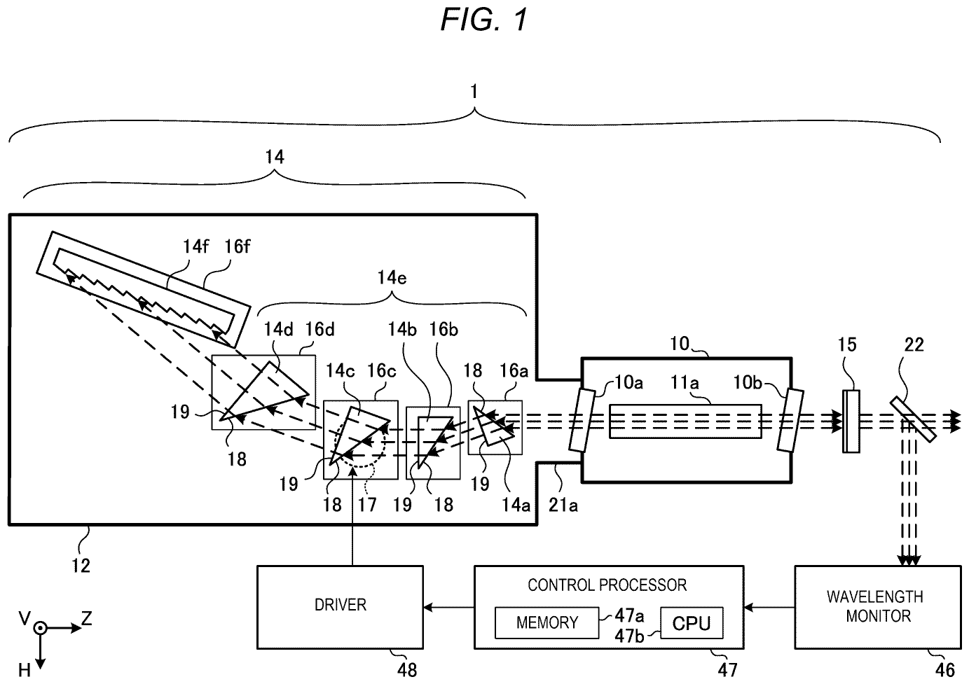

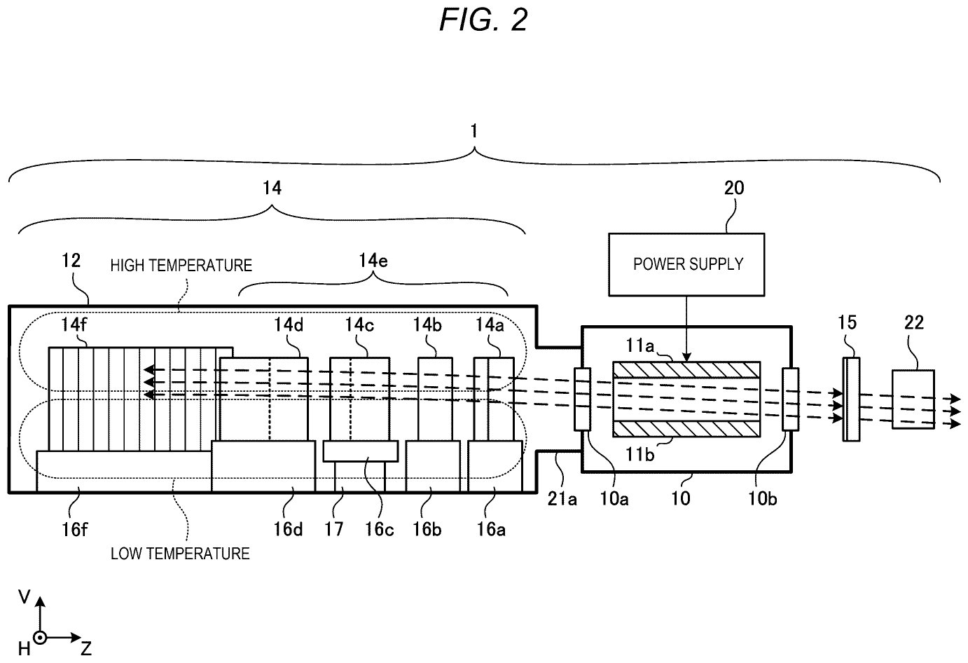

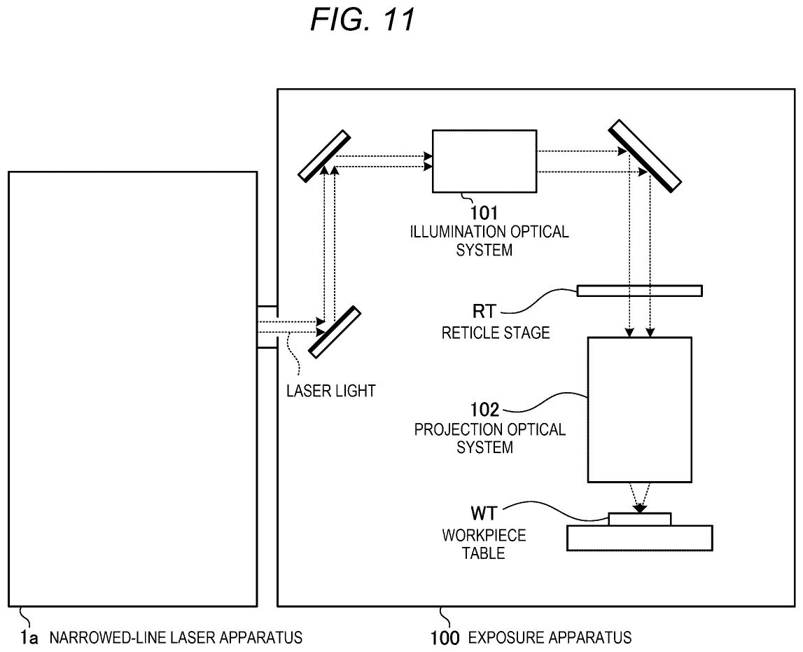

FIGS. 1 and 2 diagrammatically show the configuration of a narrowed-line laser apparatus 1 including a line narrowing module 14 according to Comparative Example. Comparative Example of the present disclosure is an aspect that the applicant is aware of as known only by the applicant, and is not a publicly known example that the applicant is self-aware of. The narrowed-line laser apparatus 1 is a master oscillator that outputs laser light caused to enter an exposure apparatus 100, which will be described later with reference to FIG. 11.

The narrowed-line laser apparatus 1 includes a laser chamber 10, a pair of discharge electrodes 11a and 11b, the line narrowing module 14, and an output coupling mirror 15. The narrowed-line laser apparatus 1 further includes a beam splitter 22, a wavelength monitor 46, a control processor 47, and a driver 48. The line narrowing module 14 and the output coupling mirror 15 constitute an optical resonator. The laser chamber 10 is disposed in the optical path of the optical resonator.

FIG. 1 shows the narrowed-line laser apparatus 1 viewed in a direction parallel to the direction in which discharge occurs between the discharge electrodes 11a and 11b. FIG. 2 shows the narrowed-line laser apparatus 1 viewed in a direction perpendicular to the direction of the discharge between the discharge electrodes 11a and 11b and perpendicular to the traveling direction of laser light output via the output coupling mirror 15. The traveling direction of the laser light output via the output coupling mirror 15 is called a Z direction. The direction of the discharge between the discharge electrodes 11a and 11b is called a V direction. The Z direction and the V direction are perpendicular to each other. The direction perpendicular to both the Z direction and the V direction is called an H direction. A −V direction approximately coincides with the direction of gravity.

The laser chamber 10 is a chamber that encapsulates a laser gas containing components of a laser medium. The laser gas contains, for example, argon gas or krypton gas as a rare gas, fluorine gas as a halogen gas, and neon gas as a buffer gas. Windows 10a and 10b are provided at opposite ends of the laser chamber 10.

The discharge electrodes 11a and 11b are disposed in the laser chamber 10. The discharge electrode 11a is connected to a power supply 20, and the discharge electrode 11b is connected to ground potential.

The windows 10a and 10b are so disposed that the surfaces thereof on which a light incident surface of the light incident on the windows is substantially parallel to an HZ plane, and that the angle of incidence of the light is substantially equal to the Brewster angle, as shown in FIG. 1.

The line narrowing module 14 includes an enlarging optical system 14e including multiple prisms, a grating 14f, and an enclosure 12. The multiple prisms include four prisms 14a to 14d. The prisms 14a to 14c correspond to the first to third prisms in the present disclosure.

The prisms 14a to 14d are each configured with calcium fluoride crystals. The prisms 14a to 14d each have two surfaces 18 and 19, through which light passes. The surfaces 18 and 19 are parallel to the V direction.

The prisms 14a to 14d are each so disposed that the traveling direction of the light passing through the surface 18 is not perpendicular to the surface 18, and that the traveling direction of the light passing through the surface 19 is substantially perpendicular to the surface 19. The light is refracted at the surface 18, and the light travels substantially straight through the surface 19. The surface 18 is coated with a film that suppresses reflection of P-polarized light. The surface 19 is coated with a film that suppresses reflection of light.

The volumes of the prisms 14a to 14d are expressed by any of the following three expressions:

prism 14d>prism 14c>prism 14b>prism 14a

prism 14d>prism 14c>prism 14b=prism 14a

prism 14d>prism 14c=prism 14b=prism 14a

The amount of material used to form each of the prisms 14a to 14d can be reduced by increasing the volume of the prism as the beam width of the light passing therethrough increases, and decreasing the volume of the prism as the beam width decreases. When the volumes of two or more of the prisms 14a to 14c are equal to each other, the two or more prisms may be identical to each other as long as they are made of the same material.

The enclosure 12 houses the prisms 14a to 14d and the grating 14f. The prism 14a is supported by a holder 16a, the prism 14b is supported by a holder 16b, the prism 14c is supported by a holder 16c, the prism 14d is supported by a holder 16d, and the grating 14f is supported by a holder 16f. The holder 16c, which supports the prism 14c, is supported by a rotating mechanism 17 including a wavelength actuator. The grating 14f is an echelle grating having a surface that contains a high-reflectance material and has a large number of grooves formed at predetermined intervals.

The enclosure 12 is connected to the laser chamber 10 via an optical path tube 21a. The interior of the optical path tube 21a and the interior of the enclosure 12 communicate with each other. An inert gas such as a nitrogen gas N2 is introduced into the interior of the enclosure 12 and the interior of the optical path tube 21a via an inert gas introduction tube that is not shown, and is discharged via an inert gas discharge tube that is not shown. The inert gas thus purges the interiors of the enclosure 12 and the optical path tube 21a.

The output coupling mirror 15 is a partially reflective mirror having one surface coated with a partially reflective film. The beam splitter 22 is disposed in the optical path of the laser light output via the output coupling mirror 15. The beam splitter 22 has one surface coated with a partially reflective film. The wavelength monitor 46 is disposed in the optical path of the laser light reflected off the beam splitter 22. The wavelength monitor 46 includes a spectrometer such as an etalon that is not shown, and an image sensor that is not shown.

The control processor 47 is a processing apparatus including a memory 47a, which stores a control program, and a CPU (central processing unit) 47b, which executes the control program. The control processor 47 is particularly configured or programmed to carry out various processes described in the present disclosure.

### 1.2 Operation

When the power supply 20 applies a high voltage to the space between the discharge electrodes 11a and 11b, discharge occurs between the discharge electrodes 11a and 11b. The energy of the discharge excites the laser medium in the laser chamber 10, and the excited laser medium transitions to a high energy level. Thereafter, when the excited laser medium transitions to a low energy level, the laser medium emits light having a wavelength according to the difference between the energy levels.

The light generated in the laser chamber 10 exits out of the laser chamber 10 via the windows 10a and 10b. The light output via the window 10a of the laser chamber 10 is refracted by the prisms 14a to 14d in a plane parallel to the HZ plane, so that the beam width in the H direction increases, and the enlarged light is incident on the grating 14f.

The light incident from the prisms 14a to 14d on the grating 14f is reflected off and diffracted by multiple grooves of the grating 14f in the direction according to the wavelength of the light. The light reflected off the multiple grooves of the grating 14f is thus dispersed in a plane parallel to the HZ plane. The grating 14f is disposed in the Littrow arrangement, which causes the angle of incidence of the light incident from the prisms 14a to 14d on the grating 14f to be equal to the angle of diffraction of the diffracted light having a desired wavelength. Light having the desired wavelength and wavelengths close thereto thus returns into the laser chamber 10 via the prisms 14a to 14d.

The prisms 14a to 14d reduce the beam width, in the H direction, of the diffracted light from the grating 14f and causes the light to return into the laser chamber 10 via the window 10a.

The output coupling mirror 15 transmits and outputs part of the light output via the window 10b of the laser chamber 10 and reflects the other part of the light back into the laser chamber 10.

The light output from the laser chamber 10 thus travels back and forth between the line narrowing module 14 and the output coupling mirror 15, and is amplified whenever passing through the discharge space between the discharge electrodes 11a and 11b. The light undergoes the line narrowing process whenever deflected back by the line narrowing module 14. Furthermore, a component polarized in the H-direction is selected by the arrangement of the windows 10a and 10b and the coating on the prisms 14a to 14d described above. The thus amplified light is output as laser light via the output coupling mirror 15. The laser light has a wavelength that belongs to the vacuum ultraviolet region. In the present disclosure, not only the light output via the output coupling mirror 15 but also the light that travels back and forth between the line narrowing module 14 and the output coupling mirror 15 may be referred to as the laser light.

The beam splitter 22 transmits part of the laser light output via the output coupling mirror 15 at high transmittance, and reflects the other part of the laser light. The laser light having passed through the beam splitter 22 enters, for example, the exposure apparatus 100. The laser light reflected off the beam splitter 22 enters the spectrometer that is not shown but is incorporated in the wavelength monitor 46. The spectrometer causes the laser light to form interference fringes at the light receiving surface of the image sensor, which is not shown but is incorporated in the wavelength monitor 46. The image sensor generates image data on the interference fringes, and transmits the image data to the control processor 47.

The control processor 47 receives data on a target wavelength, for example, from a controller that is not shown but is incorporated in the exposure apparatus 100. The control processor 47 further receives the image data from the wavelength monitor 46, and calculates the wavelength of the laser light based on the image data. The control processor 47 transmits a control signal to the driver 48 based on the data on the target wavelength and the calculated wavelength of the laser light. The driver 48 transmits a drive signal to the rotating mechanism 17 based on the control signal.

The wavelength actuator incorporated in the rotating mechanism 17 rotates the holder 16c along with the prism 14c around an axis parallel to the V direction in accordance with the drive signal from the driver 48. When the prism 14c is rotated so that the orientation of the prism 14c is adjusted, the angle of incidence of the light incident on the grating 14f is adjusted, so that the osci11a tion wavelength is adjusted. The prism 14c is not necessarily rotatable for wavelength control, and any of the prisms 14a to 14d may be rotatable.

### 1.3 Problems with Comparative Example

Calcium fluoride crystals, which are the material of the prisms 14a to 14d in Comparative Example, are not only expensive but also unstable in supply. It is therefore desirable to reduce the amount of calcium fluoride used.

Furthermore, when the narrowed-line laser apparatus 1 according to Comparative Example is continuously operated, the traveling direction of the light reflected off the grating 14f, traveling through the prisms 14a to 14d, and output from the line narrowing module 14 may deviate from an intended direction. The traveling direction of light is called pointing, and a deviation from a set value of the pointing in the V direction is defined as PointingV. The PointingV is expressed in mrad.

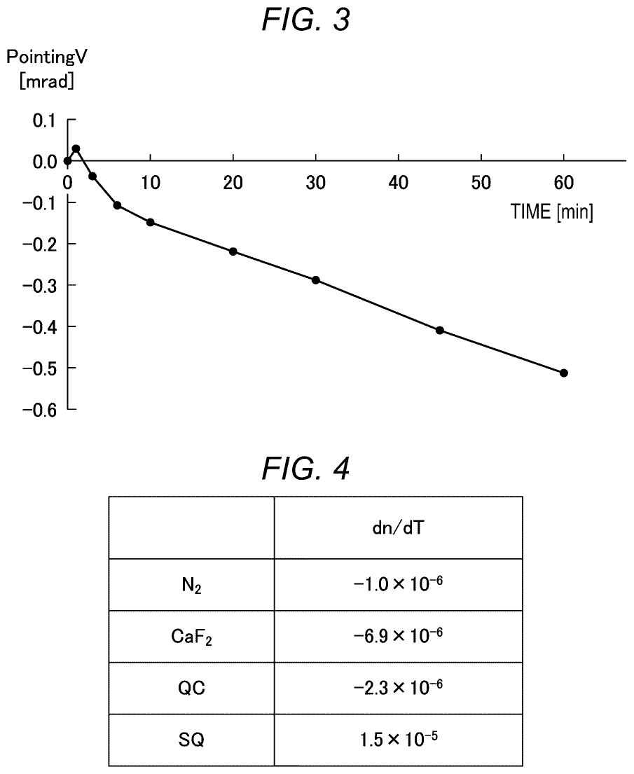

FIG. 3 is a graph showing an example of changes in PointingV according to the duration of the continuous operation of the narrowed-line laser apparatus 1 according to Comparative Example. FIG. 3 shows that the traveling direction of the light output from the line narrowing module 14 changes in −V direction over time.

Referring to FIG. 2 again, a conceivable reason for the change in PointingV will be described. When the narrowed-line laser apparatus 1 is continuously operated, the prisms 14a to 14d each absorb part of the energy of the laser light, so that the temperatures of the prisms increase.

The temperature inside each of the prisms 14a to 14d is not uniform, and a temperature distribution may occur. For example, portions of the prisms 14a to 14d far from the holders 16a to 16d may have a high temperature, while portions close to the holders 16a to 16d may not have a very high temperature. One reason why such a temperature distribution occurs is that the thermal energy in the portions of the prisms 14a to 14d that are close to the holders 16a to 16d is lost due to thermal conduction to the holders 16a to 16d. The prisms 14a to 14d are pressed against the holders 16a to 16d from the side opposite to the holders 16a to 16d by fixing members that are not shown. It is also conceivable that the fixing members are heated by scattered light, and the resultant heat thermally conducts from the fixing members to the prisms 14a to 14d and the temperatures of the portions of the prisms 14a to 14d that are far from the holders 16a to 16d increase accordingly.

The refractive index of calcium fluoride crystals have temperature dependence, and the refractive index decreases as the temperature increases. The lower the refractive index, the higher the speed at which light passes through a medium. Therefore, when the light traveling direction intersects with the temperature gradient direction, the wave front of the light inclines toward a portion where the temperature is lower. It is therefore speculated that the light traveling direction changes to a direction toward a portion where the temperature is lower, that is, to the −V direction, as shown in FIG. 2.

The absolute value of PointingV increases with time. When the absolute value exceeds a threshold, an error occurs, and the laser light cannot be generated until the error is eliminated. An embodiment described below relates to reducing the amount of calcium fluoride used as the material of the prisms 14a to 14d and suppressing the deviation of the traveling direction of the light output from the line narrowing module 14.

### 2. Line Narrowing Module 14 Including Prisms Made of Quartz Crystal and Synthetic Quartz

### 2.1 Alternative Material for Calcium Fluoride

FIG. 4 is a table showing candidates of the substance that constitutes the optical path of the enlarging optical system 14e and temperature dependence dn/dT of the refractive indices n of the candidate substances. The material of optical elements that constitute the enlarging optical system 14e needs to be highly transparent to the laser light generated by a KrF or ArF excimer laser apparatus, and quartz crystal QC and synthetic quartz SQ are conceivable as materials that replace calcium fluoride CaF₂. The substance that constitutes the optical path of the enlarging optical system 14e further includes the nitrogen gas N₂ as an inert gas that purges the interior of the enclosure 12.

As the temperature dependence dn/dT of the refractive index n, FIG. 4 shows changes in the refractive index n for the light having a wavelength of 248.4 nm in a case where a temperature T changes by 1° C. The quartz crystal QC has an absolute value of dn/dT lower than that of calcium fluoride CaF₂. In addition, the quartz crystal QC and the calcium fluoride CaF₂ both have negative dn/dT, whereas the synthetic quartz SQ has positive dn/dT.

### 2.2 Configuration

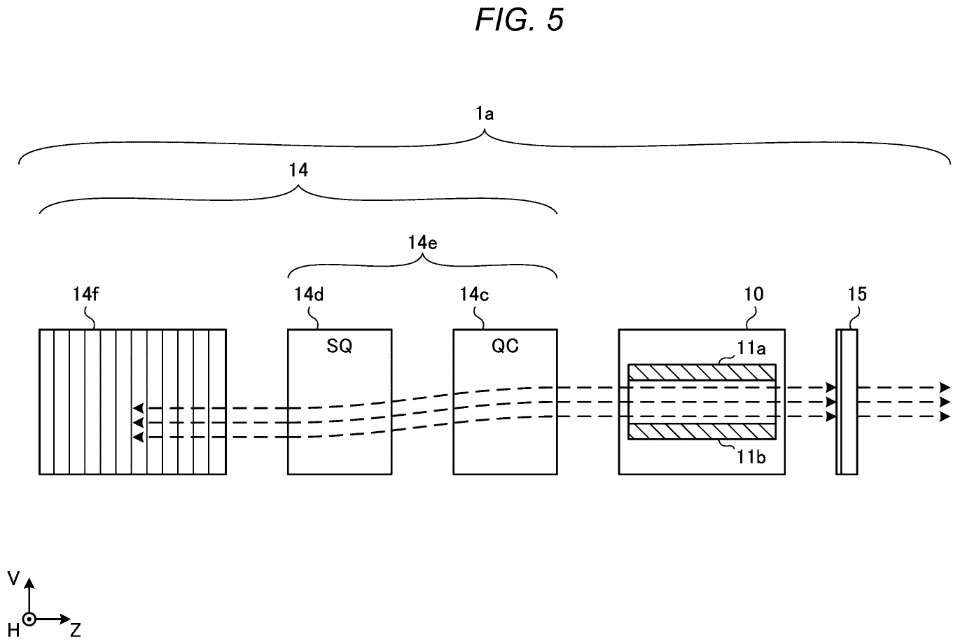

FIG. 5 shows a simplified configuration of a narrowed-line laser apparatus 1a according to a first embodiment. In the narrowed-line laser apparatus 1a, the enlarging optical system 14e includes a prism 14c made of the quartz crystal QC and a prism 14d made of the synthetic quartz SQ. When the enlarging optical system 14e includes an optical element made of the synthetic quartz SQ having positive dn/dT in addition to an optical element made of the quartz crystal QC having negative dn/dT, the inclination of the wave front of the light resulting from the temperature distribution in the enlarging optical system 14e can be cancelled out. The change in PointingV can thus be suppressed even when a temperature distribution occurs. In addition to the prism 14c made of the quartz crystal QC and the prism 14d made of the synthetic quartz SQ, a prism made of calcium fluoride CaF₂ may further be added. Note, however, that using at least one prism made of the quartz crystal QC as a prism having negative dn/dT allows reduction in the amount of calcium fluoride CaF₂ used.

However, the synthetic quartz SQ has a problem of low durability, and the quartz crystal QC has problems of birefringence and optical rotation.

As a problem of the durability of the synthetic quartz SQ, there is a known phenomenon called compaction, in which the refractive index n and the surface shape of the synthetic quartz SQ change due to a change in density thereof that occurs when the synthetic quartz SQ is irradiated with high-intensity, vacuum-ultraviolet laser light for a long time. As a method for suppressing the compaction, it is conceivable to lower the density of the energy of the light passing through the synthetic quartz SQ. Among the prisms 14a to 14d, which constitute the enlarging optical system 14e, the prism 14d is disposed at a position closest to the grating 14f, so that the light passing through the prism 14d has the lowest energy density. Using the synthetic quartz SQ as the material of the prism 14d can therefore reduce the problem of the durability.

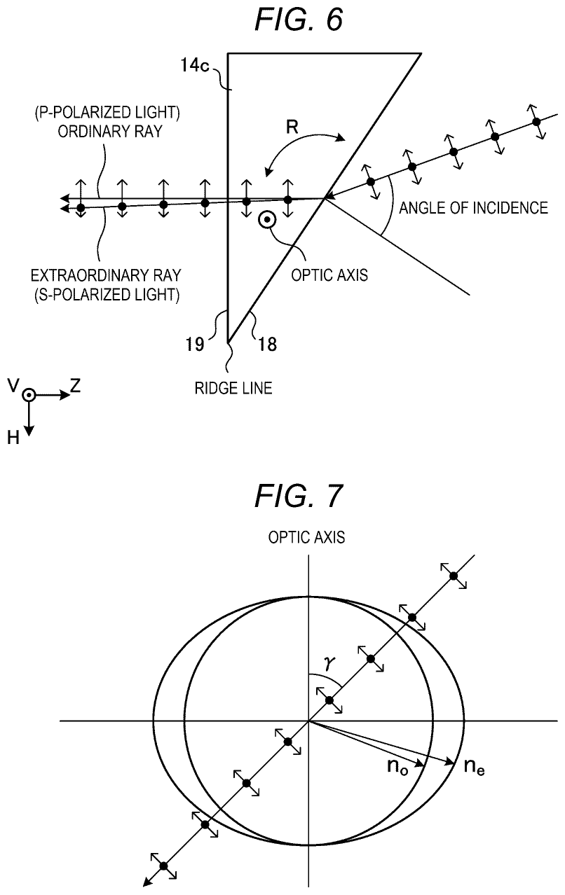

The problems of birefringence and optical rotation of the quartz crystal QC will be described with reference to FIGS. 6 to 8.

FIG. 6 shows a state in which the light output from the laser chamber 10 passes through the prism 14c toward the grating 14f. FIG. 6 shows the prism 14c, and the same applies to a case where any of the prisms 14a and 14b (see FIG. 1) is made of the quartz crystal QC. The angle between the optical path axis of the light incident on the surface 18 and a normal to the surface 18 is referred to as an angle of incidence, and the surface containing the optical path axis and the normal is referred to as a light incident plane. The optical path axis refers to the center axis of the optical path. The light incident on the surface 18 may contain two components polarized in directions perpendicular to each other. Light polarized in a polarization direction parallel to the light incident plane is referred to as P-polarized light, and light polarized in a polarization direction perpendicular to the light incident plane is referred to as S-polarized light. The polarization direction is the direction of the electric field vector of light, which is an electromagnetic wave.

The refractive index n of a medium varies in some cases depending on the polarization direction of light passing through the medium. In this case, a phenomenon called birefringence occurs. Even a medium in which birefringence can occur has a fixed refractive index n irrespective of the polarization direction of light passing along an axis in a specific direction with respect to the orientation of the crystals that constitute the medium, and the axis is referred to as an optic axis.

For light having a polarization direction perpendicular to the optic axis, a refractive index no is fixed irrespective of the traveling direction of the light passing through the medium. Such light is called ordinary rays, and the refractive index no is called an ordinary refractive index. For light having a polarization plane parallel to the optic axis, a refractive index ne varies depending on the traveling direction of the light passing through the medium. Such light is referred to as extraordinary rays, and the refractive index ne is referred to as an extraordinary refractive index. Note that the polarization plane refers to a plane containing both the polarization direction and the optical path axis.

FIG. 7 shows the relationship of an angle γ between the optical path axis and the optic axis of the quartz crystal QC with the ordinary refractive index no and the extraordinary refractive index ne. The angle γ is expressed by the inclination angle with respect to the vertical axis, and the ordinary refractive index no and the extraordinary refractive index ne are each expressed by the distance from the origin.

The prism 14c is so disposed that the optic axis thereof is parallel to the V direction, as shown in FIG. 6. The light entering the prism 14c is incident on the surface 18 in such a way that the light incident plane is parallel to the HZ plane, that is, perpendicular to the V direction. FIG. 6 therefore shows a case where the angle γ is 90 degrees. In this case, the P-polarized component forms the ordinary rays, and the S-polarized component forms the extraordinary rays. Since the P-polarized light is selected by the window 10a of the laser chamber 10, the light passing through the prism 14c can be regarded as the ordinary rays. Even when the prism 14c is rotated around an axis parallel to the V direction for wavelength control as indicated by a double-headed arrow R, the angle γ remains at 90 degrees. Therefore, even in the prism 14c made of the quartz crystal QC showing birefringence, the light passing through the prism 14c is regarded as the ordinary rays, and the birefringence is suppressed. Note in the present disclosure that the angle of 90 degrees, or being perpendicular or parallel does not mean that an angular error is not accepted, and an error within ±5 degrees is acceptable.

The optic axis of the prism 14c is parallel to a ridge line formed by the surfaces 18 and 19, through which the light entering the line narrowing module 14 passes. The prism 14c can thus be a prism processed with high accuracy, and can also be readily aligned.

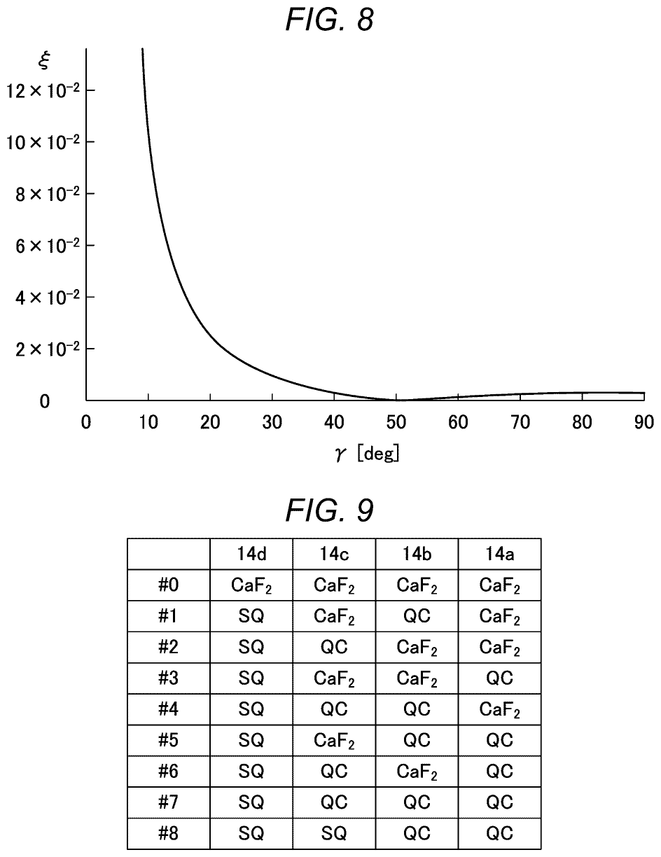

FIG. 8 shows the relationship between the angle γ of the optical path axis with respect to the optic axis of the quartz crystal QC and an optical rotation intensity ξ. Since the quartz crystal QC has a crystal structure in which silicon atoms and oxygen atoms are arranged in a spiral shape along the optic axis of the quartz crystal QC, the polarization direction of light passing through the interior of the quartz crystal QC may rotate. When the polarization direction rotates, part of the light having entered the prism 14c as P-polarized light (ordinary rays) is converted into S-polarized light (extraordinary rays) and output, so that the energy of the light is reduced in the line narrowing module 14.

When the angle γ is close to 0 degrees, the optical rotation intensity ξ is maximized, and when the angle γ is 50 degrees, the optical rotation intensity ξ is approximately zero, as shown in FIG. 8. When the angle γ is 90 degrees, the optical rotation intensity ξ is not zero, but is considerably lower than the value at the angle γ close to 0 degrees, and when the average optical path length in the prism 14c is, for example, 100 mm or shorter, the rotation of the polarization direction is considered to be negligibly small. Therefore, setting the angle γ at 90 degrees allows the influence of the optical rotation to fall within an acceptable range. Note that the average optical path length refers to the average of the optical path lengths of the light passing through the prism.

### 2.3 Effects

(1) According to the first embodiment, the line narrowing module 14 includes the enlarging optical system 14e, which enlarges and outputs the laser light, and the grating 14f, which reflectively diffracts the laser light output from the enlarging optical system 14e. The enlarging optical system 14e includes the prism 14c made of the quartz crystal QC and so disposed that the optic axis thereof is perpendicular to the light incident plane of the laser light entering the prism 14c in such a way that the laser light approaches the grating 14f, and the prism 14d made of the synthetic quartz SQ and disposed at a position closest to the grating 14f.

Since calcium fluoride CaF₂ is unstable in supply and expensive, it is desirable to reduce the amount of calcium fluoride CaF₂ used. In addition, when the prisms 14a to 14d are made of a material showing the temperature dependence dn/dT of the refractive index n, the pointing of the laser light may undesirably change due to the temperature distribution in the prism. According to the first embodiment, attention is paid to the fact that the temperature dependence dn/dT of the refractive index n has different signs for the quartz crystal QC and the synthetic quartz SQ, and the line narrowing module 14 is configured with the combination of the prism 14c made of the quartz crystal QC and the prism 14d made of the synthetic quartz SQ, so that the deviation of the pointing of the laser light due to the temperature distribution in the prism can be suppressed. Furthermore, disposing the prism 14c made of the quartz crystal QC in such a way that the optic axis thereof is perpendicular to the light incident plane of the laser light can suppress the adverse effects produced by the birefringence and the optical rotation of the quartz crystal QC. Moreover, disposing the prism 14d made of the synthetic quartz SQ at a position closest to the grating 14f can reduce the problem of the durability of the synthetic quartz SQ.

(2) According to the first embodiment, the line narrowing module 14 includes the rotating mechanism 17 including the wavelength actuator. The enlarging optical system 14e includes multiple prisms including the prism 14c made of the quartz crystal QC and the prism 14d made of the synthetic quartz SQ. The rotating mechanism 17 rotates one of the multiple prisms around an axis in the V direction parallel to the optic axis of the prism.

According to the configuration described above, even when the wavelength actuator rotates any of the multiple prisms, a change in the angle between the optical path axis of the laser light and the optic axis of the prism 14c made of the quartz crystal QC is suppressed, so that the adverse effects caused by the birefringence and the optical rotation of the prism 14c made of the quartz crystal QC can be suppressed.

(3) According to the first embodiment, the optic axis of the prism 14c made of the quartz crystal QC is parallel to the ridge line formed by the two surfaces 18 and 19 of the prism 14c made of the quartz crystal QC, through which the laser light passes.

According to the configuration described above, making the optic axis and the ridge line parallel to each other allows the prism 14c made of the quartz crystal QC to be a prism processed with high accuracy and the prism 14c made of the quartz crystal QC to be aligned with high accuracy.

(4) According to the first embodiment, the enlarging optical system 14e includes the prisms 14a, 14b, and 14c including a prism made of the quartz crystal QC, and the prism 14d made of the synthetic quartz SQ, and the prism 14d made of the synthetic quartz SQ has a volume greater than that of each of the prisms 14a, 14b, and 14c.

According to the configuration described above, the laser light enlarged by the prisms 14a, 14b and 14c can be further enlarged by the prism 14d, and the enlarged laser light can be incident on the grating 14f.

(5) According to the first embodiment, the enlarging optical system 14e includes the prisms 14a, 14b, and 14c including a prism made of the quartz crystal QC, and the prism 14d made of the synthetic quartz SQ. The prisms 14a, 14b and 14c are arranged in this order from a position farthest from the grating 14f, the prism 14c having a volume greater than or equal to that of the prism 14b, and the prism 14b having a volume greater than or equal to that of the prism 14a.

According to the configuration described above, in the enlarging optical system 14e, the beam cross section of the laser light becomes smaller at a position farther from the grating 14f, so that the volume of each of the prisms can be reduced in accordance with the beam cross section to reduce the amount of the material used.

(6) According to the first embodiment, the surfaces 18 of the prism 14c made of the quartz crystal QC and the prism 14d made of the synthetic quartz SQ, which are surfaces through which the laser light passes non-perpendicularly, are each coated with a film that suppresses reflection of P-polarized light.

The configuration described above can suppress loss of P-polarized light that becomes the ordinary rays inside the prism 14c made of the quartz crystal QC.

(7) According to the first embodiment, the surfaces 19 of the prism 14c made of the quartz crystal QC and the prism 14d made of the synthetic quartz SQ, which are surfaces through which the laser light passes perpendicularly, are each coated with a film that suppresses reflection of the light.

The configuration described above can suppress reflection of the light at the surfaces of the prisms, so that loss of the energy of the light can be suppressed.

(8) According to the first embodiment, the enlarging optical system 14e is disposed in a nitrogen-gas atmosphere.

According to the configuration described above, the cost can be reduced by using an inexpensive nitrogen gas N₂.

The first embodiment is otherwise the same as Comparative Example.

### 3. Arrangement of prisms made of various materials

### 3.1 Configuration

FIG. 9 shows combination examples #0 to #8 of the materials of which the prisms 14a to 14d, which constitute the enlarging optical system 14e, are made. The combination example #0 corresponds to Comparative Example, in which the prisms 14a to 14d are all made of calcium fluoride CaF₂. The combination examples #1 to #8 each corresponds to a second embodiment, the prism 14d disposed at a position closest to the grating 14f is made of the synthetic quartz SQ, and at least one of the prisms 14a to 14c is made of the quartz crystal QC.

The combination examples #1 to #6 each have a configuration in which at least one of the prisms 14a to 14c is made of calcium fluoride CaF₂. The combination examples #1, #2, and #4 each have a configuration in which the prism 14a, which is disposed at a position farthest from the grating 14f, is made of calcium fluoride CaF₂. Since calcium fluoride CaF₂ excels in durability, the frequency of replacement of a prism made of calcium fluoride CaF₂ can be suppressed. In particular, since the highly intense light before enlarged by the enlarging optical system 14e enters the prism 14a, the prism 14a made of calcium fluoride CaF₂ can make the line narrowing module 14 highly reliable.

The combination examples #4 to #6, in which two of the prisms 14a to 14c are made of the quartz crystal QC, allow further reduction in the amount of calcium fluoride CaF₂ used as compared with the combination examples #1 to #3. The combination example #7, in which the prisms 14a to 14c are all made of the quartz crystal QC, allows the line narrowing module 14 to be formed without using calcium fluoride CaF₂.

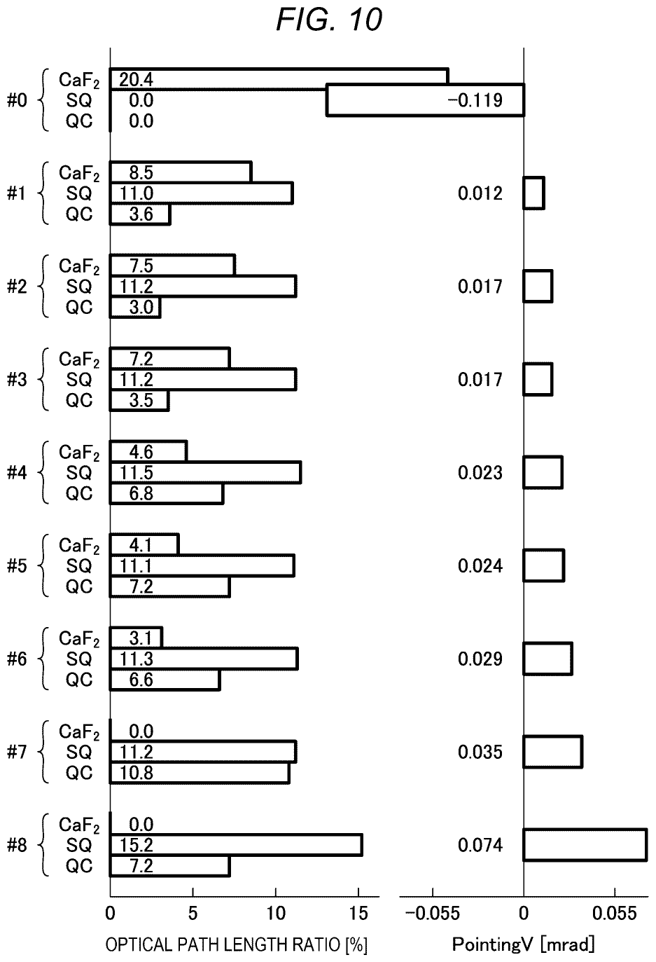

FIG. 10 shows results of calculation of the optical path length ratios and PointingV for each of the materials of which the prisms 14a to 14d are made in each of the combination examples #0 to #8. The optical path length ratios are each the ratio of the average optical path length in each of the prisms 14a to 14d to the total optical path length in the line narrowing module 14. The greater the optical path length ratio and the greater the absolute value of the temperature dependence dn/dT of the refractive index n of each of the materials, the greater the influence on PointingV in the case where the temperature distribution occurs. PointingV shown in FIG. 10 is calculated on the assumption that the temperature at the +V-direction end of each of the prisms 14a to 14d is higher by 1° C. than the temperature at −V-direction end of the prism.

In the combination Example #0 corresponding to Comparative Example, there is no prism made of the synthetic quartz SQ, so that the inclination of the wave front generated in each of the prisms 14a to 14d made of calcium fluoride CaF₂ is not canceled, and PointingV has a large negative absolute value of −0.119 mrad. In the combination example #8, which includes the two prisms 14c and 14d made of the synthetic quartz SQ, PointingV has a positive value of 0.074 mrad. The combination example #8 is advantageous in that the absolute value of PointingV smaller than that in Comparative Example suppresses the deviation of the light traveling direction, and that the line narrowing module 14 can be formed without calcium fluoride CaF₂. However, since too large an absolute value of PointingV causes an error to occur, the absolute value of PointingV is preferably smaller than or equal to 0.055 mrad. Any of the combination examples #1 to #7 including only one prism made of the synthetic quartz SQ is therefore desirable.

The prism 14d in each of the combination examples #1 to #8 corresponds to the synthetic quartz prism disclosed in the present disclosure.

The prism 14b in the combination example #1 corresponds to the first quartz crystal prism in the present disclosure, and the prisms 14a and 14c in the combination example #1 correspond to the first and second CaF₂ prisms in the present disclosure, respectively.

The prism 14c in the combination example #2 corresponds to the first quartz crystal prism in the present disclosure, and the prisms 14a and 14b in the combination example #2 correspond to the first and second CaF₂ prisms in the present disclosure, respectively.

The prism 14a in the combination example #3 corresponds to the first quartz crystal prism in the present disclosure, and the prisms 14b and 14c in the combination example #3 correspond to the first and second CaF₂ prisms in the present disclosure, respectively.

The prisms 14b and 14c in the combination example #4 correspond to the first and second quartz crystal prisms in the present disclosure, respectively, and the prism 14a in the combination example #4 corresponds to the first CaF₂ prism in the present disclosure.

The prisms 14a and 14b in the combination example #5 correspond to the first and second quartz crystal prisms in the present disclosure, respectively, and the prism 14c in the combination example #5 corresponds to the first CaF₂ prism in the present disclosure.

The prisms 14a and 14c in the combination example #6 correspond to the first and second quartz crystal prisms in the present disclosure, respectively, and the prism 14b in the combination example #6 corresponds to the first CaF₂ prism in the present disclosure.

The prisms 14a, 14b, and 14c in the combination example #7 correspond to the first, second, and third quartz crystal prisms in the present disclosure, respectively.

The prism 14a in the combination example #8 corresponds to the first quartz crystal prism in the present disclosure.

### 3.2 Effects

(9) According to the second embodiment, the enlarging optical system 14e includes a prism made of calcium fluoride CaF₂.

According to the configuration described above, using calcium fluoride CaF₂, which is a durable material having been frequently used and achieved good reputation, allows suppression of the frequency of replacement of a prism made of calcium fluoride CaF₂.

(10) According to the second embodiment, the enlarging optical system 14e includes the prism 14a made of calcium fluoride CaF₂ and disposed at a position farthest from the grating 14f.

According to the configuration described above, disposing the prism 14a made of calcium fluoride CaF₂ at a position where the highest-intensity laser light before the laser light is enlarged is incident allows suppression of the frequency of replacement of the prism 14a.

(11) According to the combination example #2 in the second embodiment, the enlarging optical system 14e includes the prism 14a made of calcium fluoride CaF₂ and disposed at a position farthest from the grating 14f, and the prism 14b made of calcium fluoride CaF₂ and disposed between the prism 14a made of calcium fluoride CaF₂ and the prism 14c made of the quartz crystal QC.

According to the configuration described above, disposing the prism 14a made of calcium fluoride CaF₂ at the position where the highest-intensity laser light is incident and the prism 14b made of calcium fluoride CaF₂ at the position where the second-highest-intensity laser light is incident allows suppression of the frequency of replacement of the prisms 14a and 14b.

(12) According to the combination example #4 in the second embodiment, the enlarging optical system 14e includes the prism 14a made of calcium fluoride CaF₂ and disposed at a position farthest from the grating 14f, and the prism 14c made of the quartz crystal QC and disposed between the prism 14b made of the quartz crystal QC and the prism 14d made of the synthetic quartz SQ.

According to the configuration described above, disposing the prism 14a made of calcium fluoride CaF₂ at a position where the highest-intensity laser light before the laser light is enlarged is incident allows suppression of the frequency of replacement of the prism 14a. Furthermore, using the prisms 14b and 14c made of the quartz crystal QC allows significant reduction in the amount of calcium fluoride CaF₂ used.

(13) According to the combination example #1 in the second embodiment, the enlarging optical system 14e includes the prism 14a made of calcium fluoride CaF₂ and disposed at a position farthest from the grating 14f, and the prism 14c made of calcium fluoride CaF₂ and disposed between the prism 14b made of the quartz crystal QC and the prism 14d made of the synthetic quartz SQ.

According to the configuration described above, disposing the prism 14a made of calcium fluoride CaF₂ at a position where the highest-intensity laser light before the laser light is enlarged is incident allows suppression of the frequency of replacement of the prism 14a. The frequency of replacement of the prism 14c made of calcium fluoride CaF₂ can also be suppressed.

(14) According to the combination example #3 in the second embodiment, the enlarging optical system 14e includes the prisms 14b and 14c made of calcium fluoride CaF₂ and disposed between the prism 14a made of the quartz crystal QC and the prism 14d made of the synthetic quartz SQ.

According to the configuration described above, the frequency of replacement of the prisms 14b and 14c made of calcium fluoride CaF₂ can be suppressed.

(15) According to the combination example #5 in the second embodiment, the enlarging optical system 14e includes the prism 14b made of the quartz crystal QC and disposed between the prism 14a made of the quartz crystal QC and the prism 14d made of the synthetic quartz SQ, and the prism 14c made of calcium fluoride CaF₂ and disposed between the prism 14b made of the quartz crystal QC and the prism 14d made of the synthetic quartz SQ.

According to the configuration described above, using the prisms 14a and 14b made of the quartz crystal QC allows significant reduction in the amount of calcium fluoride CaF₂ used. The frequency of replacement of the prism 14c made of calcium fluoride CaF₂ can also be suppressed.

(16) According to the combination example #6 in the second embodiment, the enlarging optical system 14e includes the prism 14b made of calcium fluoride CaF₂ and disposed between the prism 14a made of the quartz crystal QC and the prism 14d made of the synthetic quartz SQ, and the prism 14c made of the quartz crystal QC and disposed between the prism 14b made of calcium fluoride CaF₂ and the prism 14d made of the synthetic quartz SQ.

According to the configuration described above, using the prisms 14a and 14c made of the quartz crystal QC allows significant reduction in the amount of calcium fluoride CaF₂ used. The frequency of replacement of the prism 14b made of calcium fluoride CaF₂ can also be suppressed.

(17) According to the combination example #7 in the second embodiment, the enlarging optical system 14e includes the prisms 14b and 14c made of the quartz crystal QC and disposed between the prism 14a made of the quartz crystal QC and the prism 14d made of the synthetic quartz SQ.

According to the configuration described above, the line narrowing module 14 can be formed without calcium fluoride CaF₂.

(18) According to the second embodiment, PointingV indicating the deviation from the set value of the pointing of the laser light reflected off the grating 14f, traveling through the enlarging optical system 14e, and output from the line narrowing module 14 is smaller than or equal to 0.055 mrad.

According to the configuration described above, even when a temperature distribution occurs in the enlarging optical system 14e, the deviation of the pointing can fall within an acceptable range.

The second embodiment is otherwise the same as the first embodiment.

### 4. Others

### 4.1 Exposure apparatus 100

FIG. 11 schematically shows the configuration of the exposure apparatus 100 connected to the narrowed-line laser apparatus 1a. The narrowed-line laser apparatus la generates laser light and outputs the laser light to the exposure apparatus 100.

In FIG. 11, the exposure apparatus 100 includes an illumination optical system 101 and a projection optical system 102. The illumination optical system 101 illuminates a reticle pattern of a reticle that is not shown but is placed on a reticle stage RT with the laser light incident from the narrowed-line laser apparatus 1a. The projection optical system 102 performs reduction projection on the laser light having passed through the reticle to bring the laser light into focus on a workpiece that is not shown but is placed on a workpiece table WT. The workpiece is a photosensitive substrate onto which a photoresist has been applied, such as a semiconductor wafer. The exposure apparatus 100 translates the reticle stage RT and the workpiece table WT in synchronization with each other to expose the workpiece to the laser light having reflected the reticle pattern. The exposure apparatus 100 can manufacture electronic devices by transferring the reticle pattern onto the semiconductor wafer in the exposure step described above and then carrying out multiple other steps.

### 4.2 Supplements

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A line narrowing module comprising:
an enlarging optical system configured to enlarge and output laser light; and
a grating configured to reflectively diffract the laser light output from the enlarging optical system,
the enlarging optical system including
a first quartz crystal prism so disposed that an optic axis thereof is perpendicular to a light incident plane of the laser light entering the first quartz crystal prism in such a way that the laser light approaches the grating, and
a synthetic quartz prism disposed at a position closest to the grating.

2. The line narrowing module according to claim 1, further comprising
a wavelength actuator,
wherein the enlarging optical system includes multiple prisms including the first quartz crystal prism and the synthetic quartz prism, and
the wavelength actuator is configured to rotate one of the multiple prisms around an axis parallel to the optic axis.

3. The line narrowing module according to claim 1, wherein
the optic axis is parallel to a ridge line formed by two surfaces of the first quartz crystal prism through which the laser light passes.

4. The line narrowing module according to claim 1, wherein
the enlarging optical system includes
first, second, and third prisms including the first quartz crystal prism, and
the synthetic quartz prism, and
the synthetic quartz prism has a volume greater than a volume of each of the first, second, and third prisms.

5. The line narrowing module according to claim 1, wherein
the enlarging optical system includes
first, second, and third prisms including the first quartz crystal prism, and
the synthetic quartz prism,
the first, second, and third prisms are arranged in a presented order from a position farthest from the grating, and
the third prism has a volume greater than or equal to a volume of the second prism, and the second prism has a volume greater than or equal to a volume of the first prism.

6. The line narrowing module according to claim 1, wherein
surfaces of the first quartz crystal prism and the synthetic quartz prism that are surfaces through which the laser light passes non-perpendicularly are each coated with a film configured to suppress reflection of P-polarized light.

7. The line narrowing module according to claim 1, wherein
surfaces of the first quartz crystal prism and the synthetic quartz prism that are surfaces through which the laser light passes perpendicularly are each coated with a film configured to suppress reflection of light.

8. The line narrowing module according to claim 1, wherein
the enlarging optical system is disposed in a nitrogen-gas atmosphere.

9. The line narrowing module according to claim 1, wherein
the enlarging optical system further includes a first CaF₂ prism.

10. The line narrowing module according to claim 1, wherein
the enlarging optical system further includes a first CaF₂ prism disposed at a position farthest from the grating.

11. The line narrowing module according to claim 1, wherein
the enlarging optical system further includes
a first CaF₂ prism disposed at a position farthest from the grating, and
a second CaF₂ prism disposed between the first CaF₂ prism and the first quartz crystal prism.

12. The line narrowing module according to claim 1, wherein
the enlarging optical system further includes
a first CaF₂ prism disposed at a position farthest from the grating, and
a second quartz crystal prism disposed between the first quartz crystal prism and the synthetic quartz prism.

13. The line narrowing module according to claim 1, wherein
the enlarging optical system further includes
a first CaF₂ prism disposed at a position farthest from the grating, and
a second CaF₂ prism disposed between the first quartz crystal prism and the synthetic quartz prism.

14. The line narrowing module according to claim 1, wherein
the enlarging optical system further includes
a first CaF₂ prism and a second CaF₂ prism disposed between the first quartz crystal prism and the synthetic quartz prism.

15. The line narrowing module according to claim 1, wherein
the enlarging optical system further includes
a second quartz crystal prism disposed between the first quartz crystal prism and the synthetic quartz prism, and
a first CaF₂ prism disposed between the second quartz crystal prism and the synthetic quartz prism.

16. The line narrowing module according to claim 1, wherein
the enlarging optical system further includes
a first CaF₂ prism disposed between the first quartz crystal prism and the synthetic quartz prism, and
a second quartz crystal prism disposed between the first CaF₂ prism and the synthetic quartz prism.

17. The line narrowing module according to claim 1, wherein
the enlarging optical system further includes
a second quartz crystal prism and a third quartz crystal prism disposed between the first quartz crystal prism and the synthetic quartz prism.

18. The line narrowing module according to claim 1, wherein
deviation from a set value of pointing of the laser light reflected off the grating, traveling through the enlarging optical system, and output from the line narrowing module is smaller than or equal to 0.055 mrad.

19. A narrowed-line laser apparatus comprising:
a line narrowing module including an enlarging optical system configured to enlarge and output laser light, and a grating configured to reflectively diffract the laser light output from the enlarging optical system;
an output coupling mirror; and
a laser chamber disposed in an optical path of an optical resonator and including a pair of discharge electrodes, the optical resonator including the line narrowing module and the output coupling mirror,
the enlarging optical system including
a first quartz crystal prism so disposed that an optic axis thereof is perpendicular to a light incident plane of the laser light entering the first quartz crystal prism in such a way that the laser light approaches the grating, and
a synthetic quartz prism disposed at a position closest to the grating.

20. A method for manufacturing electronic devices, the method comprising:
generating laser light by using a narrowed-line laser apparatus;
outputting the laser light to an exposure apparatus; and
exposing a photosensitive substrate to the laser light in the exposure apparatus to manufacture the electronic devices,
the narrowed-line laser apparatus including
a line narrowing module including an enlarging optical system configured to enlarge and output the laser light, and a grating configured to reflectively diffract the laser light output from the enlarging optical system,
an output coupling mirror, and
a laser chamber disposed in an optical path of an optical resonator and including a pair of discharge electrodes, the optical resonator including the line narrowing module and the output coupling mirror,
the enlarging optical system including
a first quartz crystal prism so disposed that an optic axis thereof is perpendicular to a light incident plane of the laser light entering the first quartz crystal prism in such a way that the laser light approaches the grating, and
a synthetic quartz prism disposed at a position closest to the grating.
